(19) United States
(12) Patent Application Publication
(10) Pub. No.: US 2005/0223288 A1
(43) Pub. Date: Oct. 6, 2005

(54) Diagnostic fault detection and isolation

(75) Inventors: Richard D. Berbaum, Maine, NY (US); Edward R. Bestle, Owego, NY (US)

Correspondence Address: MILES & STOCKBRIDGE PC, 1751 PINNACLE DRIVE, SUITE 500, MCLEAN, VA, 22102-3833, US

(73) Assignee: Lockheed Martin Corporation

(21) Appl. No.: 10/998,802

(22) Filed: Nov. 30, 2004

Related U.S. Application Data
(60) Provisional application No. 60/543,618, filed on Feb. 12, 2004.

(51) Int. Cl. G06F 11/00

(52) U.S. Cl. 714/29

(57) ABSTRACT

A system and method for diagnostic fault detection and isolation is provided, wherein COTS/MOTS subsystems of a system under test are evaluated in a hierarchical manner providing improved test coverage and a reduction in ambiguity group size. The diagnostic fault detection and isolation method may proceed from automatic built-in-test to disruptive built-in-test and finally to manual tests. At each stage of the testing, results may be evaluated to determine which, if any, components need replacing. The systems and methods of the present invention are suited to testing systems that incorporate COTS/MOTS subsystem components, and for use with an interactive electronic technical manual (IETM).

This application claims the benefit of U.S. Provisional Application No. 60/543,618, filed Feb. 12, 2004, which is incorporated herein by reference.

The present invention relates generally to diagnostic systems and methods and, more particularly, to diagnostic systems and methods for troubleshooting a complex system, such as a military aircraft, to identify one or more components, such as one or more weapon replaceable assemblies (WRAs) or lower level components, that has failed.

Complex systems, such as, for example, military aircraft may be designed using existing Commercial Off-The-Shelf (COTS) components or Modified Off-The-Shelf (MOTS) components. The COTS/MOTS design methodology allows the designer or system engineer to utilize readily available components that may meet the system requirements with little or no modification. Another advantage of the COTS/MOTS components may be that a design and development cycle is not required for the individual components, thus freeing a system engineer to focus on system integration and testing issues.

While systems designed with COTS/MOTS components may enjoy the advantages described above, they may also be subject to limitations. One of the potential limitations of systems designed with COTS/MOTS components may be testability. The testability of a system may rely on the individual test features built into the COTS/MOTS component, thus the limited test capability may not fully provide interface testing, subsystem testing, and/or full system testing capabilities.

A typical requirement of complex systems, particularly in military applications, may be for the provision of diagnostic fault detection and isolation capabilities. Further, based on the complexity of the system under test (SUT), the diagnostic fault detection and isolation system may be required to automatically interact with the SUT.

Maintenance, including the reliable troubleshooting of complex systems, is a common issue in various industries, including the aircraft and automotive industries, the electronics industry, the defense industry and the like. In the military, for example, maintenance of an aircraft may be of importance to ensure the continued safe, efficient and effective operation of the aircraft. Minimum ground time between flights may be desirable to maximize asset utilization and to meet the established mission goals. Therefore, the time allocated to unscheduled maintenance may often be limited to the relatively short time that the aircraft is required to be on the ground in order to permit reloading of munitions and ordnance, to refuel and to otherwise service the aircraft.

Properly performing unscheduled maintenance in both an accurate and timely manner is critical in a battlefield situation. Troubleshooting a combat aircraft which may be an extremely large and complex system comprised of many interconnected subsystems may be particularly difficult. In the COTS/MOTS design methodology, each subsystem may typically be comprised of many WRAs that may be individually replaceable. A WRA may be mechanical, such as a valve or a pump; electrical, such as a switch or relay; or electronic, such as an autopilot or a flight management computer. Many WRAs are, in turn, interconnected. As such, the symptoms described by flight deck effects or other observations may indicate that a fault in more than one WRA may explain the presence of the observed symptoms. At that point, there may be ambiguity about which WRA(s) have actually failed. Additional information may be needed to disambiguate between the possibilities.

Given the complexity of modern military aircraft, computers are often used to assist in the diagnostic and maintenance processes. An example is the Integrated Electronic Technical Manual (IETM). The IETM is an electronic version of the technical manual for an aircraft that is coupled with a computer system capable of interfacing with the aircraft to interrogate the systems of the aircraft in order to better diagnose the aircraft.

The present invention provides a diagnostic fault detection and isolation development approach that may be compatible with automated equipment such as the IETM for example. Further, the systems and methods of the present invention provide the flexibility to integrate with the various COTS/MOTS subsystem components of an SUT. Accordingly, the systems and methods of the present invention may overcome the testability limitation of systems designed using COTS/MOTS components by providing a diagnostic approach that is configurable to test each unit under test (UUT), subsystem and/or WRA within an SUT, thereby providing a comprehensive testing capability to a system that incorporates COTS/MOTS components.

### BRIEF DESCRIPTION OF THE DRAWINGS

FIG. 1 is a block diagram of an exemplary embodiment of a diagnostic fault detection and isolation system in accordance with the present invention;

FIG. 2 is a block diagram showing, in greater detail, an exemplary interface between a system under test and a diagnostic fault detection and isolation system in accordance with the present invention;

FIG. 3 is a block diagram showing, in greater detail, an exemplary interface between a system under test and a diagnostic fault detection and isolation system in accordance with the present invention;

FIG. 4 is a block diagram showing the details of an exemplary interface between an exemplary embodiment of a Unit Under Test (UUT) server and an exemplary COTS component in accordance with the present invention; and

FIG. 5 is a flowchart showing an exemplary system-level diagnostic fault detection and isolation sequence in accordance with the present invention.

### DETAILED DESCRIPTION

The diagnostic fault detection and isolation systems and methods of the present invention may be described in relation to an Integrated Electronic Technical Manual (IETM) for purposes of illustration. However, it should be appreciated that the diagnostic fault detection and isolation systems and methods of the present invention may be used with other types of equipment and in other operational environments, such as on a personal computer, incorporated within a system under test, on a handheld computing device, and/or the like.

According to the present invention, improved diagnostic fault detection and isolation systems and methods are provided. Since the diagnostic fault detection and isolation system and method are particularly useful for the aircraft industry, the diagnostic fault detection and isolation system and method will be hereinafter described and illustrated in conjunction with the troubleshooting of an aircraft. An aircraft may be an airplane, a helicopter, a unmanned aerial vehicle, a spacecraft, an airship, and/or the like. However, the diagnostic system and method may be used to troubleshoot any system having a number of interconnected components, such as the complex systems created by the automotive, marine, electronics, power generation and computer industries, for example.

In general, the diagnostic fault detection and isolation methods and systems of the present invention are based on a divide and concur flow control methodology. Functional test tasks (called checkout tasks) can be built from a number of sequential subtasks. The sequential execution of these subtasks builds on the successful completion of prior subtasks. This allows the system to fault diagnose/fault isolate (FD/FI) root causes of failures. It would not be valid to FD/FI a UUT if the interface to the UUT or the controlling computer to the UUT were failing. To test a subsystem or WRA, the required components between the IETM and the UUT are verified as operational, such as, for example, connectivity to the controlling computer. Once the controlling computer is verified as functional, the I/O from the UUT is verified as valid before testing the UUT.

For example, in testing a WRA that is controlled by a mission computer over a 1553 interface, assume the 1553 interface is not connected to the mission computer or the wires have been severed for both channels. The IETM diagnostics of the present invention first verifies communications to the mission computer. Once communication has been validated, the mission computer is tested. Once the mission computer has been verified to be operational and no BIT errors are reported, the 1553 interface is checked for communication to the various subsystems. In this case, no valid communication to any of the WRAs is possible since the interface is not connected or broken. Fault detection has occurred within the critical path to the UUT and therefore would require fault isolation to the root cause since the 1553 is required to communicate to the UUT. Fault isolation may be accomplished by sequential execution of those subtasks built upon the successful completion of prior subtasks. In this case, 1553 channels are routed via different paths of the system, thus eliminating the possibility the problem could be any place else but near or at the source of the 1553 communication. Through the various subtask tests (verify connection, inspections, and testing continuity, etc . . . ) of the 1553 prerequisite test, the fault would be isolated to the interface wiring. If this prerequisite test were not executed, FD/FI would not have correctly isolated to the root cause. Testing of the UUT never occurred in the above example because the fault was detected and isolated within the prerequisite test (root cause). The prerequisite tests in this example were the ETM, IETM to mission computer connection, mission computer, and then mission computer interface to the UUT.

Variations of the prerequisite tests are determined by physical hierarchy of the SUT and UUT. In the example above, if the UUT were connected to an ARINC 429 interface instead of the 1553, for example, and the ARINC 429 interface was working, the UUT would have been tested because it is not dependent upon the 1553 being functional. In fact, the 1553 prerequisite would not have been called since it is not part of the data path to the UUT.

Accordingly, prerequisite testing is broken down into the finest parts to allow specific testing to be conducted so the path between the IETM and the UUT can be validated without interfering with the test results.

The fault group for the above example fault would have been automatically isolated to the interface wiring at the mission computer, 1553 address, and lastly the mission computer. As determined by eliminating those tests that did pass, the physical connection and routing of the interface wiring, and architecture of the system under test. In this case coordination of the I/O status of all the other WRAs on the 1553 may determine that the other WRAs could not communicate to the controlling computer.

Fault isolation ends when a fault group has been determined. The fault group at this point is a list of faults that can represent the root cause of the problem. Selecting one of the faults in the fault group will link you to a Remove and Replace (R/R) procedure or a repair procedure depending on the fault.

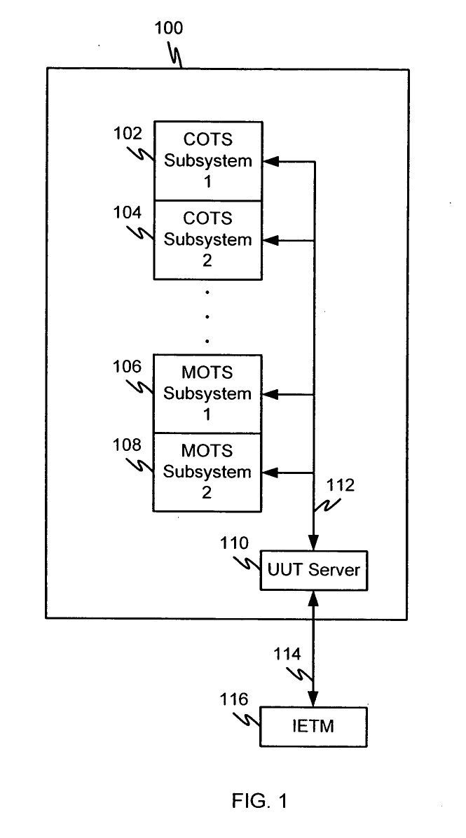

FIG. 1 is a block diagram of an exemplary embodiment of a diagnostic fault detection and isolation system in accordance with the present invention. In particular, the system under test (SUT) 100 comprises a first COTS subsystem 102, a second COTS subsystem 104, a first MOTS subsystem 106 and a second MOTS subsystem 108, all connected by links 112 to a Unit Under Test (UUT) server 110. The exemplary SUT 100 shown in FIG. 1 is a limited system for purposes of illustration and may not represent the potential complexity of an aircraft or other complex system. It should be appreciated that the systems and methods of the present invention can be used on complex systems with varying quantities and configurations of subsystems. An IETM 116 is connected by a link 114 to the UUT server 110. The links 112 and the link 114 may be wired links, such as, for example, serial, Ethernet, USB, and/or the like. Alternatively, the links 112 and the link 114 may be wireless links, such as, for example, radio frequency, light, and/or the like. In general, the links 112 and the link 114 may be any known, or later developed element(s), capable of interfacing with the components as shown in FIG. 1 and communicating data between the components as shown in FIG. 1 may be used.

In operation, the IETM 116 executes a diagnostic fault detection and isolation task sequence in accordance with the present invention. The diagnostic task sequence generates commands, which are sent from the IETM 116 to the UUT server 110 via the link 114. The commands test the subsystem in a hierarchical fashion and build on one another. In other words, the diagnostic fault detection task sequence has been designed to test the subsystem in an order that permits subsequent tests to build on the results of previous tests. For example, the diagnostic fault detection task sequence may test the COTS box 1 102 first, then test the MOTS box 2 108, then test the MOTS box 1 106 and, finally, test COTS box 2 104. The order of tests may depend on a number of factors including a subsystem function and a subsystem interconnection configuration.

The UUT server 110 provides access to the COTS/MOTS subsystem built-in-test functionality, as well as the subsystem interface functionality. The UUT 110 server provides a low-level interface between the IETM 116 and the individual subsystems. By keeping the UUT server 110 operating as a low-level interface, the subsystems may contain operational software and the IETM 116 may contain high-level test software. This layering of the functionality may be efficient for purposes of testing and certification. In safety critical systems, such as, for example, avionics, it may often be desirable to keep the amount of software, and hence the amount of software changes, to a minimum in order to reduce the need for re-testing and/or re-qualification when the software is updated with changes.

The diagnostic fault detection and isolation system may be operated fully automatically, fully manually or in a combination of automatic and manual modes.

The diagnostic fault detection and isolation system provides fast built-in-test result interpretation. This may allow a complex system to be diagnosed rapidly. In addition to automated testing and interpreting of results, the diagnostic fault detection and isolation system also provides the capability for manual testing in cases where automated testing may be either impractical or impossible. In such cases, the diagnostic fault detection and isolation sequence guides the user through the steps necessary to perform the manual test. Further, the IETM queries the user for result input and uses the results for fault detection and isolation in conjunction with automated test results. The combination of automated and manual testing provides a balance between speed of testing and completeness of test coverage, depending upon the contemplated uses of the present invention.

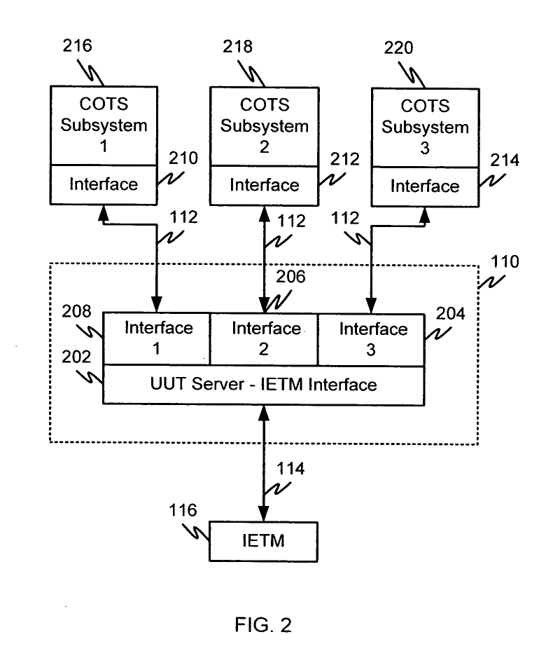

FIG. 2 is a block diagram showing, in greater detail, an exemplary interface between a system under test and a diagnostic fault detection and isolation system in accordance with the present invention. In particular, an IETM 116 is connected via a link 114 to a UUT-IETM interface 202 of a UUT server 110. The UUT-IETM interface 202 is connected to three interfaces, interface 1 208, interface 2 206 and interface 3 204. Interface 1 208 is connected via a link 112 to an interface 210 in COTS subsystem 1 216. Interface 2 206 is connected via a link 112 to an interface 212 in COTS subsystem 2 218. Interface 3 204 is connected via a link 112 to an interface 214 in COTS subsystem 3 220.

In operation, the IETM 116 sends commands and receives responses via a link 114 to UUT-IETM interface 202. The UUT-IETM interface 202 routes the commands and responses to one of the three interfaces (204-208) according to the appropriate COTS subsystem (216-220) under test. Each interface (204-208) in the UUT server is configured according to the COTS interface (210-214) that it is connected to.

The exemplary embodiment shown in FIG. 2 is for illustrative purposes only. It should be appreciated that the systems and methods of the present invention may be used in a variety of subsystem and interface configurations.

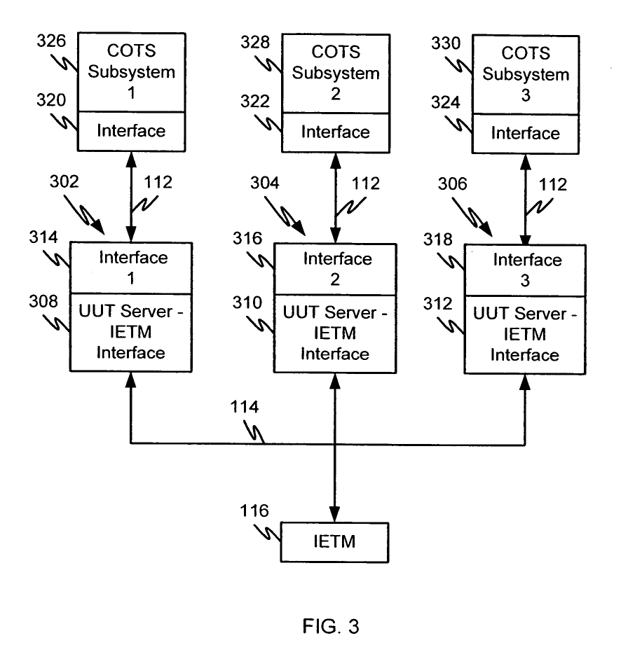

As an alternative configuration, the UUT server may be unique for each subsystem. FIG. 3 is a block diagram showing, in greater detail, an exemplary interface between a system under test and a diagnostic fault detection and isolation system in accordance with the present invention, wherein the UUT server is unique for each subsystem. In particular, the IETM 116 is connected via links 114 to UUT server 1 302, UUT server 2 304 and UUT server 3 306. UUT server 1 302 comprises a UUT-IETM interface 308 and a subsystem interface 314. UUT server 2 304 comprises a UUT-IETM interface 310 and a subsystem interface 316. UUT server 3 306 comprises a UUT-IETM interface 312 and a subsystem interface 318. Each of the UUT server (302-306) subsystem interfaces (314-318) is connected via a link 112 to a respective COTS subsystem interface (320-324).

In operation, the IETM 116 routes commands to the appropriate UUT server in accordance with the function being tested in the diagnostic fault detection and isolation test sequence. For example, when a test sequence requires a test command be sent to COTS subsystem 1 326, a test command is sent from the IETM 116 via a link 114 to the UUT-ETM interface 308 and then to the UUT server 302 subsystem interface 314. The UUT server 302 subsystem interface 314 sends the command via a link 112 to the COTS interface 320, which is coupled to the COTS subsystem 326.

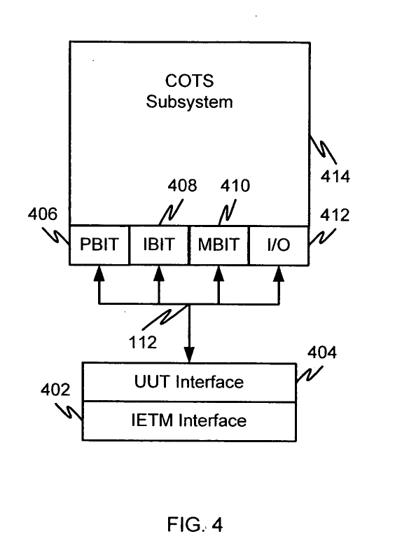

FIG. 4 is a block diagram showing the details of an exemplary interface between an exemplary embodiment of a Unit Under Test (UUT) server and an exemplary COTS component in accordance with the present invention. In particular, an IETM interface 402 is coupled to a UUT interface 404. The UUT Interface 404 is coupled via links 112 to a PBIT element 406, and IBIT element 408, an MBIT element 410 and an I/O element 412 of COTS subsystem 414.

In operation, the UUT interface 404 issues commands and receives responses from the interface element (PBIT 406, IBIT 408, MBIT 410, or I/0 412) of COTS subsystem 414 that corresponding to commands received from the IETM (not shown) via the IETM interface 402.

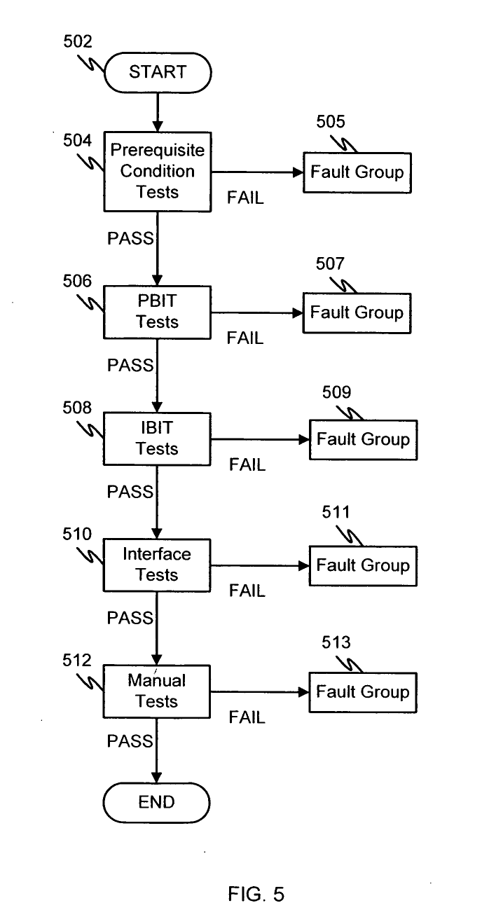

FIG. 5 is a flowchart showing an exemplary system-level diagnostic fault detection and isolation sequence in accordance with the present invention. In particular, control beings at step 502 and continues to step 504.

In step 504, prerequisite condition checks are performed. The prerequisite tests are selected based on physical hierarchy. For example, in order to test a flight display, the prerequisite tests required may include the IETM to mission computer interface, the mission computer to communications bus interface, and the communications bus to flight display interface. Once all of the necessary prerequisite tests have passed, the test of the actual WRA can proceed. If a fault is found in the prerequisite condition test results, then control transfers to a fault group 505 for fault isolation and remove and replace indications. If no fault is found, control continues to step 506.

In step 506, Periodic BIT (PBIT) is performed. PBIT is a non-operator initiated BIT that runs periodically in the background of a subsystem and is non-disruptive to the subsystem. If there are any faults detected in the PBIT results, then control transfers to a fault group 507 for fault isolation and remove and replace indications. If no fault is found, control continues to step 508.

In step 508, Initiated BIT (IBIT) tests are performed. The IBIT test task returns when IBIT is passed or skipped. If any faults are detected during IBIT, then the task ends and control transfers to a fault group 509 for fault isolation and remove and replace indications. If the IBIT tests pass, control continues to step 510.

In step 510, interface tests are performed. The interface test routines test the data communication between subsystems. The interface tests do not require operator intervention. Two general types of faults may be detected in the interface tests, a fault that is beyond the subsystem being tested and a fault that is within the subsystem being tested. If a fault is detected that is beyond the subsystem being tested, the WRA interface test will return with an error code and a message indicating a new work order is needed and what test needs to be performed. If a fault is detected in a WRA that is within the subsystem or wiring being tested, then control transfers to a fault group 511 for fault isolation and remove and replace indications. If no fault is found, control continues to step 512.

In step 512, manual test tasks are performed. A manual test task will not return unless it is passes or is skipped by the operator. If a fault is detected during a manual test task, control transfers to a fault group 513 for fault isolation and remove and replace indications. If no faults are detected, control continues to step 516, where control terminates.

Although the diagnostic fault detection and isolation systems and methods have been described and illustrated in conjunction with the troubleshooting of a military aircraft, the diagnostic fault detection and isolation systems and methods can be used to troubleshoot any system having a number of interconnected components, such as the complex systems created by the automotive, marine, electronics, power generation and computer industries. As such, the foregoing description of the utilization of the diagnostic fault detection and isolation systems and methods in the military aircraft industry was for purposes of illustration and example and not of limitation since the diagnostic procedure described above is equally applicable in many different industries.

According to the present invention, a system for diagnostic fault detection and isolation can be implemented on a general-purpose computer, a special-purpose computer, a programmed microprocessor or microcontroller and peripheral integrated circuit element, and ASIC or other integrated circuit, a digital signal processor, a hardwired electronic or logic circuit such as a discrete element circuit, a programmed logic device such as a PLD, PLA, FPGA, PAL, neural network, artificial intelligence device, or the like. In general, any process capable of implementing the functions described herein can be used to implement a system for fault detection and isolation according to this invention.

Furthermore, the disclosed system may be implemented in software using object or object-oriented software development environments that may provide portable source code that can be used on a variety of computer platforms. Alternatively, the disclosed system for diagnostic fault detection and isolation may be implemented partially or fully in hardware using standard logic circuits or a VLSI design. Other hardware or software can be used to implement the systems in accordance with this invention depending on the speed and/or efficiency requirements of the systems, the particular function, and/or a particular software or hardware system, microprocessor, or microcomputer system being utilized. The diagnostic fault detection and isolation system illustrated herein can readily be implemented in hardware and/or software using any known or later developed systems or structures, devices and/or software by those of ordinary skill in the applicable art from the functional description provided herein and with a general basic knowledge of the computer and electrical arts.

Moreover, the disclosed methods may be readily implemented in software executed on programmed general-purpose computer, a special purpose computer, a microprocessor, or the like. In these instances, the systems and methods of this invention can be implemented as a program embedded on a personal computer such as JAVA®, XML or CGI script, as a resource residing on a server or graphics workstation, as a routine embedded in a dedicated encoding/decoding system, as an artificial intelligence program, neural network program, or the like. The system can also be implemented by physically incorporating the system and method into a software and/or hardware system, such as the hardware and software systems of an integrated electronic technical manual.

It is, therefore, apparent that there is provided in accordance with the present invention, systems and methods for diagnostic fault detection and isolation. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

1. A fault detection and isolation method for detecting and isolating faults in a complex system comprising:
identifying at least one subsystem of the complex system for testing;
generating a test sequence defining an order of testing of the subsystems identified for testing and an order of individual tests to be performed on each subsystem identified for testing; and
performing a subsystem fault detection and isolation test for each subsystem of the complex system identified for testing using a stand-alone test interface module, wherein the subsystem fault detection and diagnostic test comprises:
checking prerequisite conditions;
requesting periodic built-in-test results if available, if periodic built-in-test results are not available, then requesting periodic built-in-test be performed and requesting the results of the periodic built-in-test;
receiving periodic built-in-test result data;
testing interfaces;
requesting execution of initiated built-in-test;
requesting the results of the initiated built-in-test once it has completed;
receiving initiated built-in-test result data; and
indicating any detected faults and isolating and indicating one or more components that are associated with the detected faults.

2. The fault detection and isolation method of claim 1, further comprising:
performing a manual test;
receiving results of the manual test; and
incorporating the manual test results in the detecting and isolating of faults.

3. The fault detection and isolation method of claim 1, wherein the generating a test sequence defining an order of testing of the subsystems identified for testing and an order of individual tests to be performed on each subsystem identified for testing, is based on the physical hierarchy of the subsystems of the complex system.

4. The fault detection and isolation method of claim 1, wherein the periodic built-in-test comprises:
performing mode tests;
performing data input and output tests;
evaluating detailed built-in-test results in order to determine if faults occurred; and
isolating faults to one or more candidate components associated with the detected faults.

5. The fault detection and isolation method of claim 1, wherein the interface testing comprises:
requesting message data;
receiving message data
checking message status;
checking the message status and data in order to determine if faults occurred; and
isolating faults to one or more candidate components associated with the detected faults.

6. The fault detection and isolation method of claim 1, wherein the initiated built-in-test comprises:
prompting a user prior to starting a lengthy test, wherein a lengthy test is one that will exceed a predetermined time to complete, if a test is lengthy;
requesting execution of an initiated built-in-test;
receiving the results of the initiated built-in-test; and
checking initiated built-in-test results in order to determine if there were any faults; and
isolating any detected faults to one or more candidate components associated with the detected faults.

7. The fault detection and isolation method of claim 2, wherein the manual test comprises:
presenting a user with an explanation of the manual test to be performed;
waiting for the user to perform the manual test;
receiving input from the user indicating results of the manual test;
checking the manual test results in order to determine if there were any faults; and
isolating any faults to one or more candidate components associated with the detected faults.

8. The fault detection and isolation method of claim 1, further comprising identifying a set of repairs associated with the detected faults and the one or more candidate components associated with the detected faults.

9. The fault detection and isolation method of claim 1, wherein the method is adapted to perform fault detection and isolation of an aircraft.

10. The fault detection and isolation method of claim 9, wherein the aircraft is a helicopter.

11. A fault detection and isolation system for detecting and isolating faults in a complex system comprising:
an interface coupled to a subsystem of the complex system identified for testing, wherein said interface is a stand-alone module and is configured to transfer data bi-directionally between the subsystem and a processor;
a processor coupled to the interface, comprising a memory including software instructions for a test program sequence that cause the processor to perform the steps of:
generating periodic built-in-test commands;
generating interface test commands;
generating initiated built-in-test commands;
generating manual test prompts
receiving test result data from the periodic built-in-test, the interface test, the initiated built-in-test and the manual test;
processing the test result data; and
detecting and isolating any faults to one or more candidate components associated with the detected faults;
wherein the processor detects and isolates faults in the complex system.

12. The fault detection and isolation system of claim 11, further comprising a display element coupled to the processor and configured to display faults and maintenance procedures responsive to the test program sequence.

13. The fault detection and isolation system of claim 11, wherein the interface is at least partially housed within the subsystem and is in an aircraft.

14. The fault detection and isolation system of claim 11, wherein the interface is at least partially housed within the processor.

15. The fault detection and isolation system of claim 11, wherein the interface is coupled to the processor and subsystem via a wireless coupling.

16. The fault detection and isolation system of claim 12, wherein the processor and the display element are part of an integrated electronic technical manual.

17. The fault detection and isolation system of claim 11, wherein the complex system is an aircraft.

18. The fault detection and isolation system of claim 17, wherein the aircraft is a helicopter.

19. The fault detection and isolation system of claim 11, wherein the test program sequence is written in a mark-up language.

20. A diagnostic system for detecting and isolating faults in a helicopter comprising:
an interface coupled to a subsystem of the complex system identified for testing, wherein said interface is a stand-alone module and is configured to transfer data bi-directionally between the subsystem and a processor;
a processor coupled to the interface, comprising a memory including software instructions for a test program sequence that cause the processor to perform the steps of:
generating periodic built-in-test commands;
generating interface test commands;
generating initiated built-in-test commands;
generating manual test prompts
receiving test result data from the periodic built-in-test, the interface test, the initiated built-in-test and the manual test;
processing the test result data; and
detecting and isolating any faults to one or more candidate components associated with the detected faults, wherein the processor detects and isolates faults in the complex system; and
a display element coupled to the processor for displaying faults and corrective procedures associated with any detected faults and the one or more candidate components associated with the detected faults, said display element responsive to the processor and test program sequence software.

21. The diagnostic system of claim 20, wherein the interface is at least partially housed within the helicopter.

22. The diagnostic system of claim 20, wherein the interface is at least partially housed within the processor.

23. The diagnostic system of claim 20, wherein the interface is coupled to the processor and subsystem via a wireless coupling.

24. The diagnostic system of claim 20, wherein the processor and the display element are part of an integrated electronic technical manual.
